(19) United States
(12) Patent Application Publication
(10) Pub. No.: US 2019/0171734 A1
(43) Pub. Date: Jun. 6, 2019

(54) INFORMATION PRESENTATION DEVICE, INFORMATION PRESENTATION SYSTEM, AND INFORMATION PRESENTATION METHOD

(71) Applicants: Toshiyuki FURUTA, Kanagawa (JP); Katsumi Kanasaki, Tokyo (JP); Kiyohiko Shinomiya, Tokyo (JP); Kai Yuu, Kanagawa (JP); Ryo Furutani, Kanagawa (JP)

(72) Inventors: Toshiyuki FURUTA, Kanagawa (JP); Katsumi Kanasaki, Tokyo (JP); Kiyohiko Shinomiya, Tokyo (JP); Kai Yuu, Kanagawa (JP); Ryo Furutani, Kanagawa (JP)

(21) Appl. No.: 16/162,581

(22) Filed: Oct. 17, 2018

(30) Foreign Application Priority Data
Dec. 1, 2017 (JP) 2017-232043

(51) Int. Cl. G06F 17/30; G06F 3/16; G06K 9/00

(52) U.S. Cl. CPC G06F 17/30253; G06F 17/30867; G06K 9/00456; G06F 3/167; G06F 17/30268

(57) ABSTRACT

An information presentation device, system, and method. The information presentation system includes the information presentation device, a recognition unit, an extraction unit and an external search unit. The information presentation method includes searching information sources indicated in a plurality of search conditions for a keyword extracted from an utterance or an image displayed on a display and presenting each search result corresponding to each of the search conditions on the display in a discriminable form.

### CROSS-REFERENCE TO RELAYED APPLICATION

This patent application is based on and claims priority pursuant to 35 U.S.C. § 119(a) to Japanese Patent Application No. 2017-232043, filed on Dec. 1, 2017, in the Japan Patent Office, the entire disclosure of which is hereby incorporated by reference herein.

### BACKGROUND

### Technical Field

The present disclosure relates to an information presentation device, an information presentation system, and an information presentation method.

### Discussion of the Background Art

In meetings, projecting materials on a projector or a large display and discussing while writing on a whiteboard is becoming a common style. A system to help advance the meeting by performing information search based on the contents being spoken or projected and automatically presenting the search results to meeting participants has already been disclosed.

As a system for improving the efficiency of the meeting, systems using artificial intelligence (AI) to understand the utterances in the meeting and displaying keywords and recommendation information on a wall, a table, etc. are known.

### SUMMARY

Embodiments of the present disclosure described herein provide an improved information presentation device, system, and method. The information presentation system includes the information presentation device, a recognition unit, an extraction unit and an external search unit. The information presentation method includes searching information sources indicated in a plurality of search conditions for a keyword extracted from an utterance or an image displayed on a display and presenting each search result corresponding to each of the search conditions on the display in a discriminable form.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating overall configuration of an information presentation system according to an embodiment of the present disclosure;

FIG. 2 is a diagram illustrating an example of how a meeting looks using the information presentation system according to an embodiment of the present disclosure;

FIG. 3 is a block diagram illustrating a hardware configuration of an information presentation device according to an embodiment of the present disclosure;

FIG. 4 is a block diagram illustrating a functional configuration of the information presentation system according to an embodiment of the present disclosure;

FIG. 5 is a diagram illustrating an example of how icons corresponding to a plurality of search conditions are displayed in the information presentation device according to an embodiment of the present disclosure;

FIG. 6 is a diagram illustrating examples of the icons respectively corresponding to the plurality of search conditions according to an embodiment of the present disclosure;

FIG. 7A and FIG. 7B are sequence diagrams illustrating an example of information presentation processing by the information presentation system according to an embodiment of the present disclosure;

FIG. 8 is a diagram illustrating examples of scores of search results displayed on the icons corresponding to the plurality of search conditions in the information presentation device according to an embodiment of the present disclosure; and

FIG. 9 is a diagram illustrating an example of search result displayed when any of the icons corresponding to the plurality of search conditions is selected in the information presentation device according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an”, and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

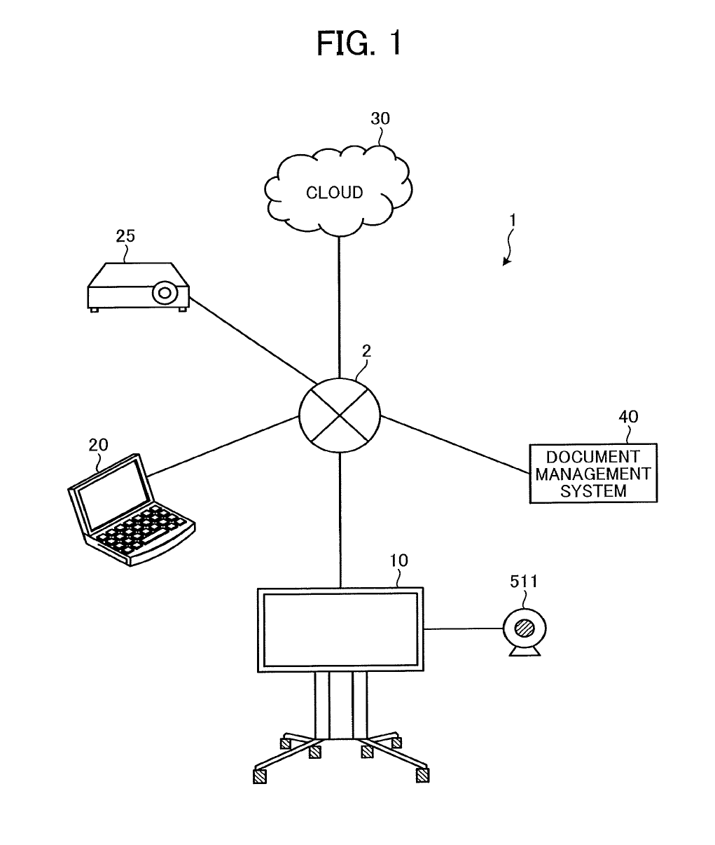

Hereinafter, embodiments of an information presentation device, an information presentation system, and an information presentation method according to the present disclosure will be described in detail with reference to FIG. 1 to FIG. 9. The present disclosure, however, is not limited to the following embodiments, and the constituent elements of the following embodiments include those which can be easily conceived by those skilled in the art, those being substantially the same ones, and those being within equivalent ranges. Furthermore, various omissions, substitutions, changes and combinations of the constituent elements can be made without departing from the gist of the following embodiments.

Overall Configuration of the Information Presentation System

FIG. 1 is a diagram illustrating overall configuration of the information presentation system according to the present embodiment. A description is given below of the overall configuration of the information presentation system 1 according to the present embodiment with reference to FIG. 1.

As illustrated in FIG. 1, the information presentation system 1 according to the present embodiment includes the information presentation device 10, a personal computer (PC) 20, a projector 25, a cloud 30, and a document management system 40, communicably connected to each other via a network 2. The network 2 is, for example, a network such as a local area network (LAN), a wide area network (WAN), a dedicated line, or the internet. In the network 2, data communication is performed by a communication protocol such as transmission control protocol/internet protocol (TCP/IP). Note that a wired network and a wireless network may be mixed in the network 2.

The information presentation device 10 is a device that searches and displays information that is considered useful for a meeting and is, for example, an electronic whiteboard called interactive whiteboard (IWB). Hereinafter, it is assumed that the information presentation device 10 is an IWB. A camera 511 is connected to the information presentation device 10. The camera 511 is, for example, an imaging device to capture an image projected by the projector 25.

The PC 20 is, for example, an information processing apparatus that transmits an image to be displayed on the information presentation device 10.

The projector 25 is an image projection device to project data received from an external device (for example, the PC 20) via the network 2 onto a projection target surface such as a screen. Although the projector 25 is assumed to be connected to the network 2 hereafter, alternatively the projector 25 may be connected to the PC 20, for example, and the data received from the PC 20 (for example, image displayed on the PC 20) may be projected.

The cloud 30 is an aggregate of computer resources for providing a function (cloud service) needed by a user (meeting participant) using the information presentation device 10 via the network 2 according to a use request from the information presentation device 10.

The document management system 40 is, for example, a database for managing various documents created within the meeting participants' company.

The configuration illustrated in FIG. 1 is just an example of the configuration of the information presentation system 1, and the information presentation system 1 may have any other suitable system configuration. For example, when it is not necessary to transmit an image from the PC 20 to the information presentation device 10 for display, the PC 20 may not be included in the information presentation system 1. Further, when it is not necessary to capture the image projected by the projector 25, the projector 25 and the camera 511 may not be included in the information presentation system 1.

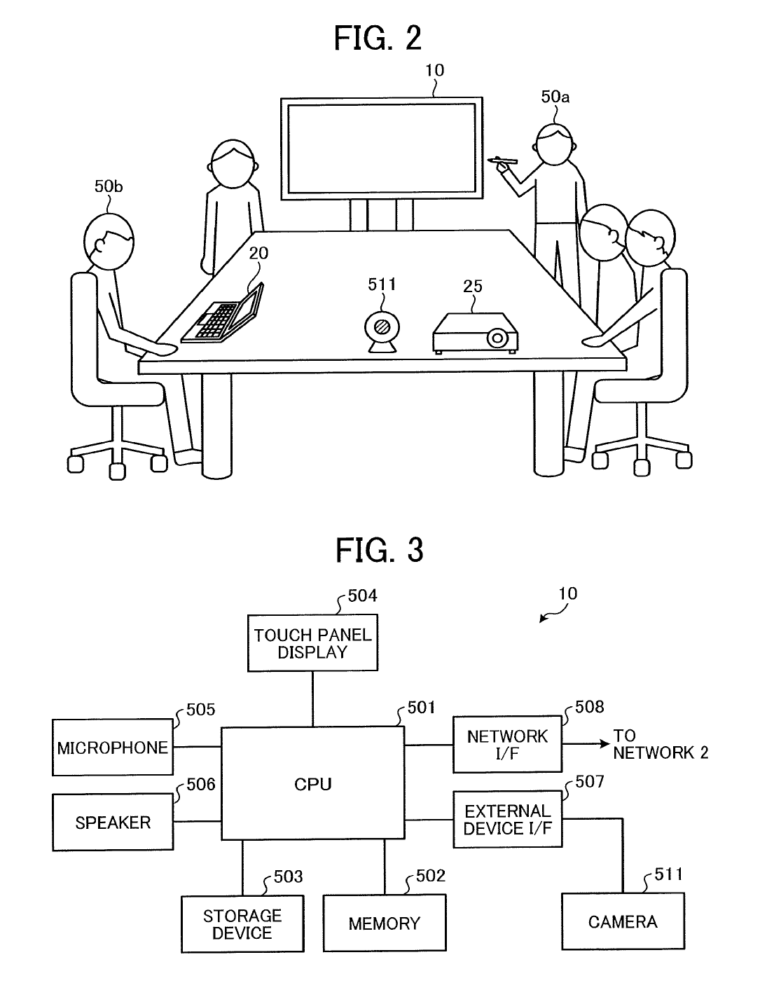

FIG. 2 is a diagram illustrating an example of how the meeting looks using the information presentation system according to the present embodiment.

FIG. 2 illustrates a scene in which the information presentation system 1 according to the present embodiment is used in a meeting. In FIG. 2, the information presentation device 10 is the IWB, and a participant 50a, who is one of the meeting participants, uses an electronic pen (stylus) to write the contents of discussion on a touch panel display of the information presentation device 10. Also, from the PC 20 operated by a participant 50b who is another one of the meeting participants, an image to be shared by the meeting participants is transmitted to the information presentation device 10 and displayed on the touch panel display. A projector 25 is installed on a desk in the meeting room, and the projector 25 projects an image on the screen on the near side in FIG. 2. A camera 511 is installed on the desk in the meeting room, and for example, the camera 511 captures the image projected by the projector 25. In the example illustrated in FIG. 2, the camera 511 captures the image projected by the projector 25, but the camera may instead be used to capture the handwritten image on the white board.

FIG. 3 is a block diagram illustrating the hardware configuration of the information presentation device 10 according to the present embodiment. A description is given of the hardware configuration of the information presentation device 10 according to the present embodiment with reference to FIG. 3.

As illustrated in FIG. 3, the information presentation device 10 according to the present embodiment includes a central processing unit (CPU) 501, a memory 502, a storage device 503, the touch panel display 504, a microphone 505, a speaker 506, an external device interface (I/F) 507, and a network I/F 508.

The CPU 501 is an integrated circuit to control the overall operation of the information presentation device 10. The CPU 501 may be, for example, a CPU included in a System on Chip (SoC), instead of a single integrated circuit.

The memory 502 is a storage device such as a volatile random access memory (RAM) used as a work area of the CPU 501.

The storage device 503 is a nonvolatile auxiliary storage for storing various programs for executing the processing of the information presentation device 10, image data and audio data, a keyword obtained from the image data and the audio data, and various data such as search results based on the keyword. The storage device 503 is, for example, a flash memory, a hard disk drive (HDD), a solid state drive (SSD), or the like.

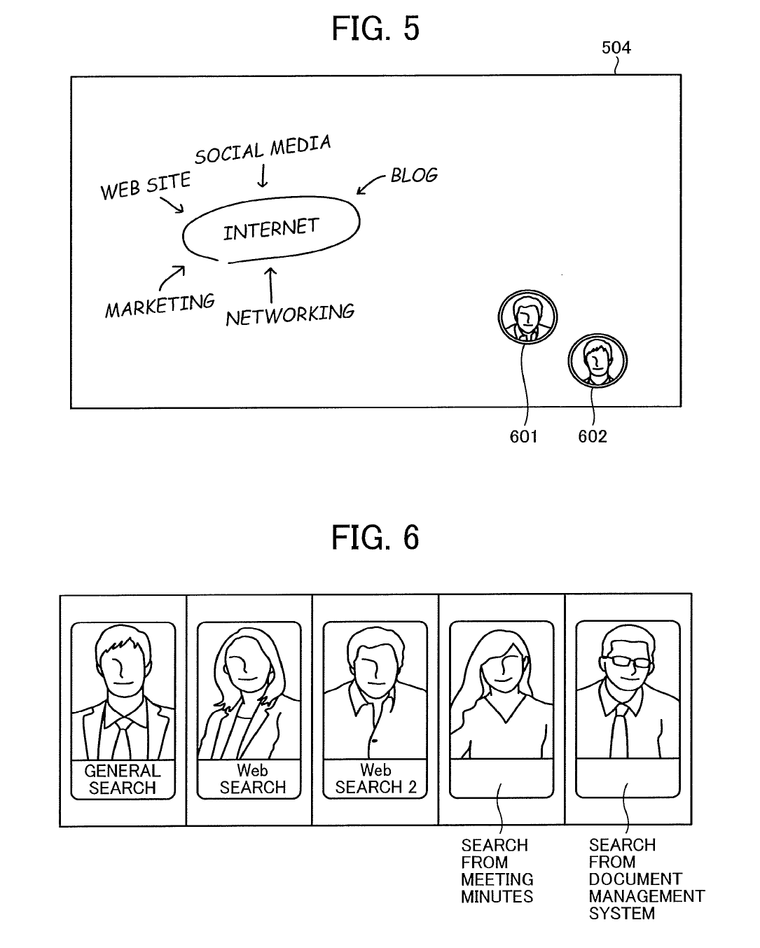

The touch panel display 504 is a display device with a function of displaying image data and the like on a display device and a touch detection function of sending coordinates of the user's electronic pen (stylus) touching the touch panel to the CPU 501. The touch panel display 504, as illustrated in FIG. 5 to be described later, functions as the electronic whiteboard by displaying the trajectory tracing the surface of the panel with the electronic pen. The display device of the touch panel display 504 is, for example, a liquid crystal display (LCD), an organic electro-luminescence (EL) display, or the like.

The microphone 505 is a sound collecting device to input voice of the participant participating in the meeting. For example, in FIG. 2, the microphone 505 is installed on the upper side of the display (touch panel display 504) and the like and inputs the voice of the participant facing the information presentation device 10.

The speaker 506 is a device to output sound under the control of the CPU 501. For example, in FIG. 2, the speaker 506 is installed at the lower side of the display (touch panel display 504) and for example, when the meeting is held with a partner base in a remote place, the speaker 506 receives audio data of the partner base and outputs the audio data as the voice of the partner base.

The external device I/F 507 is an interface for connecting external devices. The external device I/F 507 is a universal serial bus (USB) interface, a recommended standard (RS)-232 C interface, or the like. As illustrated in FIG. 3, the camera 511 is connected to the external device I/F 507. The camera 511 is an imaging device including a lens and a solid-state imaging device that digitizes an image of a subject by converting light into electric charge. For example, the camera 511 captures an image projected by the projector 25. Complementary metal oxide semiconductor (CMOS) or charge coupled device (CCD) or the like is used as the solid-state imaging device. As described in FIG. 1 and the like, the camera 511 may be a single built-in imaging device or may be a camera built in the PC 20 illustrated in FIG. 1, for example. In this case, the image data captured by the built-in camera is transmitted to the information presentation device 10 via the PC 20 and the network 2.

The network I/F 508 is an interface for exchanging data with the outside using the network 2 such as the internet illustrated in FIG. 1. The network I/F 508 is, for example, a network interface card (NIC) or the like. 10Base-T, 100Base-TX, 1000Base-T, or the like is cited as a standard corresponding to the network I/F 508 in the case of a wired LAN and 802.11a/b/g/n and the like is cited as a standard corresponding to the network I/F 508 in the case of a wireless LAN.

Note that the hardware configuration of the information presentation device 10 is not limited to the configuration illustrated in FIG. 3. For example, the information presentation device 10 may include a read only memory (ROM) or the like, which is a nonvolatile storage device that stores firmware or the like to control the information presentation device 10. As illustrated in FIG. 3, the memory 502, the storage device 503, the touch panel display 504, the microphone 505, the speaker 506, the external device I/F 507, and the network I/F 508 are connected to the CPU 501, however, the present disclosure is not limited to such a configuration, and the components described above may be communicably connected with each other through a bus such as an address bus or a data bus.

In addition, in FIG. 3, the information presentation device 10 has a configuration in which the microphone 505 and the speaker 506 are built in the main body, but at least one of the microphone 505 and the speaker 506 may be configured as a separate unit. For example, when the speaker 506 is not a built-in external device but a separate external device, the speaker 506 may be connected to the information presentation device 10 via the external device I/F 507 described above.

Functional Configuration of the Information Presentation System

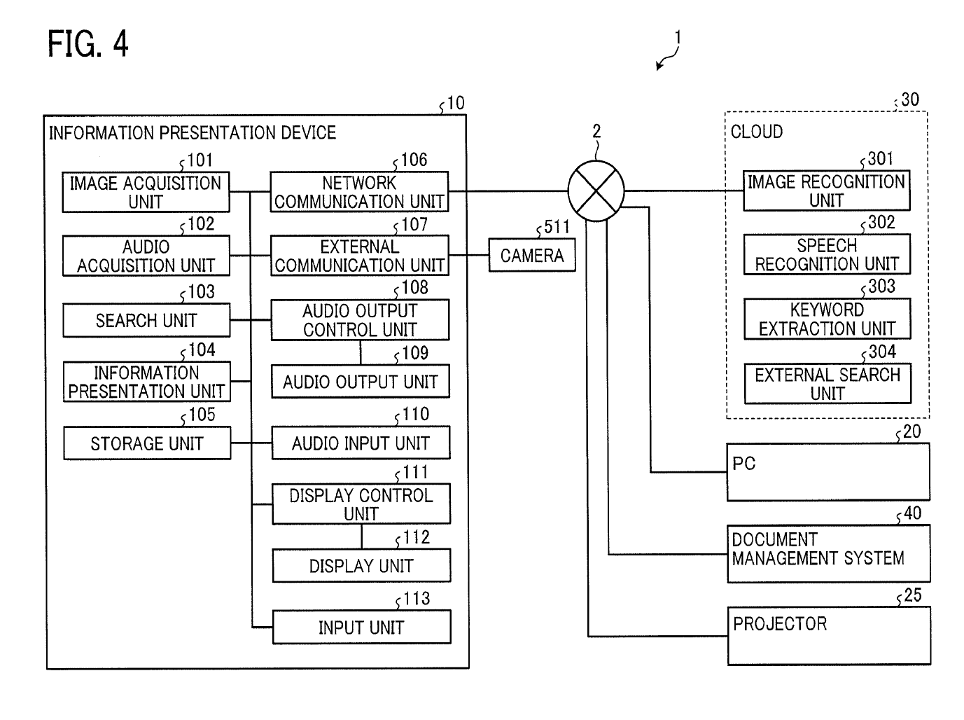

FIG. 4 is a block diagram illustrating a functional configuration of the information presentation system 1 according to the present embodiment. A description is given below of the overall functional configuration of the information presentation system 1 according to the present embodiment with reference to FIG. 4.

As illustrated in FIG. 4, the information presentation device 10 according to the present embodiment includes an image acquisition unit 101, an audio acquisition unit 102, a search unit 103, an information presentation unit 104, a storage unit 105, a network communication unit 106, an external communication unit 107, an audio output control unit 108, an audio output unit 109, an audio input unit 110, a display control unit 111, a display unit 112, and an input unit 113.

The image acquisition unit 101 is a functional unit that acquires the image data of the projected image by the projector 25 captured by the camera 511 and the image data displayed on the display unit 112 (that is, the touch panel display 504). Further, the image acquisition unit 101 may acquire the image data or the like stored in the PC 20. For example, the image acquisition unit 101 may acquire the image data at regular intervals or only intermittently. The image acquisition unit 101 transmits the acquired image data to the cloud 30 via the network communication unit 106 and the network 2 to recognize text string using image recognition. The image acquisition unit 101 is implemented by, for example, a program executed by the CPU 501 illustrated in FIG. 3. When the image data projected by the projector 25 can be acquired directly from the projector 25, the image acquisition unit 101 may acquire the image data of the projected image directly from the projector 25 instead of the camera 511.

The audio acquisition unit 102 is a functional unit to acquire the audio data from the voice signal collected (input) by the microphone 505. For example, the audio acquisition unit 102 may acquire the audio data periodically, intermittently, or during a period in which the voice signal is detected. The audio acquisition unit 102 transmits the acquired audio data to the cloud 30 via the network communication unit 106 and the network 2 to recognize text string using speech recognition. The audio acquisition unit 102 is implemented by, for example, a program executed by the CPU 501 illustrated in FIG. 3.

The search unit 103 instructs keyword searching based on a plurality of preset search conditions for the keyword extracted from the text string recognized by the image recognition on the image data and the speech recognition on the audio data by the cloud 30. The search unit 103 transmits an instruction for the keyword search along with the keyword and the search conditions to the cloud 30 or the document management system 40 and the like. Note that the search unit 103 itself may perform the keyword search based on the search conditions. The search unit 103 is implemented, for example, by a program executed by the CPU 501 illustrated in FIG. 3.

The information presentation unit 104 is a functional unit to receive a search result from the cloud 30 based on the search conditions transmitted from the search unit 103 and causes the display control unit 111 to display (present) the search result on the display unit 112. The information presentation unit 104 is implemented, for example, by a program executed by the CPU 501 illustrated in FIG. 3. Note that the information presentation unit 104 causing the display control unit 111 to display some information on the display unit 112, may be simply expressed as the information presentation unit 104 displays information on the display unit 112.

The storage unit 105 is a functional unit to store various programs for executing the processing carried out by the information presentation device 10, the image data and the audio data, the keyword obtained from the image data and the audio data, and various data such as the search result based on the keyword. The storage unit 105 is implemented by the storage device 503 illustrated in FIG. 3.

The network communication unit 106 is a functional unit to perform data communication with the cloud 30, the PC 20, the document management system 40, and other external devices or external systems via the network 2. The network communication unit 106 is implemented by the network I/F 508 illustrated in FIG. 3.

The external communication unit 107 is a functional unit to perform data communication with the external device. The external communication unit 107 is implemented by the external device I/F 507 illustrated in FIG. 3.

The audio output control unit 108 is a functional unit to control the audio output unit 109 to output various sounds. The audio output control unit 108 is implemented, for example, by the CPU 501 illustrated in FIG. 3 executing a program.

The audio output unit 109 is a functional unit to output various sounds under the control of the audio output control unit 108. The audio output unit 109 is implemented by the speaker 506 illustrated in FIG. 3.

The audio input unit 110 is a functional unit to input the audio data. The audio input unit 110 is implemented by the microphone 505 illustrated in FIG. 3.

The display control unit 111 is a functional unit to control to display various images and video images, information handwritten by the electronic pen, and the like on the display unit 112. The display control unit 111 is implemented, for example, by the CPU 501 illustrated in FIG. 3 executing a program.

The display unit 112 is a functional unit to display various images and video images and information handwritten by the electronic pen under the control of the display control unit 111. The display unit 112 is implemented by the display function of the display device in the touch panel display 504 illustrated in FIG. 3.

The input unit 113 is a functional unit to accept written input from the electronic pen (stylus) of the user (for example, one of the meeting participants). The input unit 113 is implemented by the touch detection function on the touch panel display 504 illustrated in FIG. 3.

Note that the image acquisition unit 101, the audio acquisition unit 102, the search unit 103, the information presentation unit 104, the storage unit 105, the network communication unit 106, the external communication unit 107, the audio output control unit 108, the audio output unit 109, the audio input unit 110, the display control unit 111, the display unit 112, and the input unit 113 of the information presentation device 10 are conceptual representations of functions, and the present disclosure is not limited to such a configuration. For example, the plurality of functional units illustrated as independent functional units in the information presentation device 10 illustrated in FIG. 4 may be configured as one functional unit. Conversely, in the information presentation device 10 illustrated in FIG. 4, the function of one functional unit may be divided into a plurality of functional units.

In addition, functional units of the information presentation device 10 described in FIG. 4 are the main functional units, and the functions of the information presentation device 10 are not limited to the functions described.

In addition, each functional unit of the information presentation device 10 illustrated in FIG. 4 may be provided in the PC 20. In this case, the PC 20 functions as the information presentation device 10.

As illustrated in FIG. 4, the cloud 30 includes an image recognition unit 301 (an example of a recognition unit), a speech recognition unit 302 (another example of the recognition unit), a keyword extraction unit 303 (an extraction unit), and an external search unit 304.

The image recognition unit 301 is a functional unit to perform the image recognition on the image data received from the information presentation device 10 via the network 2 and recognizes the text string included in the image data. As a method of the image recognition, a well-known optical character recognition (OCR) method may be used. The image recognition unit 301 is implemented by the computer resources included in the cloud 30.

The speech recognition unit 302 is a functional unit to perform the speech recognition on the audio data received from the information presentation device 10 via the network 2 and recognizes text string included in the audio data. As a method of the speech recognition, a method using a known Hidden Markov Model may be used. The speech recognition unit 302 is implemented by the computer resources included in the cloud 30.

The keyword extraction unit 303 is a functional unit to extract the keyword from the text string recognized by the image recognition unit 301 and the speech recognition unit 302. As an example of a method of extracting the keyword from the text string, a method such as extracting a word by decomposing the word into parts of speech by morpheme analysis and excluding particles or the like can be mentioned. The keyword extraction unit 303 is implemented by the computer resources included in the cloud 30.

The external search unit 304 is a functional unit to search the keyword based on the search conditions received from the search unit 103 of the information presentation device 10 together with the search instruction via the network 2. The keyword search by the external search unit 304 is not a simple keyword search but the keyword search based on the search conditions designated in advance. Various search conditions can be specified beforehand, such as an information source (web or document management system 40 or the like) to be searched, a search engine to be used, a genre, an update date of information to be searched, and additional keywords to be searched in conjunction such as “security”, “politics”, “world heritage”, or the like.

Note that the image recognition unit 301, the speech recognition unit 302, the keyword extraction unit 303, and the external search unit 304 of the cloud 30 illustrated in FIG. 4 are conceptual representations of functions, and the present disclosure is not limited to the illustrated configuration. For example, the plurality of functional units illustrated as independent functional units in the cloud 30 in FIG. 4 may be configured as one functional unit. On the other hand, in the cloud 30 illustrated in FIG. 4, the function of one functional unit may be divided into a plurality of functional units.

Although the image recognition unit 301, the speech recognition unit 302, the keyword extraction unit 303, and the external search unit 304 are collectively described as the functions implemented by the cloud 30, the present disclosure is not limited to the configuration where all the functional units are implemented by specific computer resources. In addition, the image recognition unit 301, the speech recognition unit 302, the keyword extraction unit 303, and the external search unit 304 are not limited to being implemented by the cloud 30 but may be implemented by the information presentation device 10 or another server device.

Outline of Display of Search Condition and Search Result

FIG. 5 is a diagram illustrating examples of the icons corresponding to the search conditions displayed in the information presentation device according to the present embodiment. FIG. 6 is a diagram illustrating examples of the icons respectively corresponding to the plurality of search conditions. With reference to FIG. 5 and FIG. 6, the outlines of the search conditions and the display manner of the search result in the information presentation device 10 is described.

FIG. 5 illustrates the contents displayed on the touch panel display 504 (display unit 112) according to the present embodiment. On the left side of the touch panel display 504, contents relating to discussion in the meeting are written by the user (for example, one of the meeting participants) with the electronic pen. The keyword is extracted from the image data of the contents written on the touch panel display 504, and the search unit 103 instructs the keyword search based on the preset search conditions.

The information presentation unit 104 displays the icons corresponding to the search results of the respective search conditions on the touch panel display 504 (display unit 112), as illustrated in the right side of FIG. 5. By displaying the icons, search results based on the search conditions are presented in discriminable form. In the example illustrated in FIG. 5, two icons 601 and 602 including a symbol of a person are displayed, which means that there are two search conditions and two search results obtained according to each search condition.

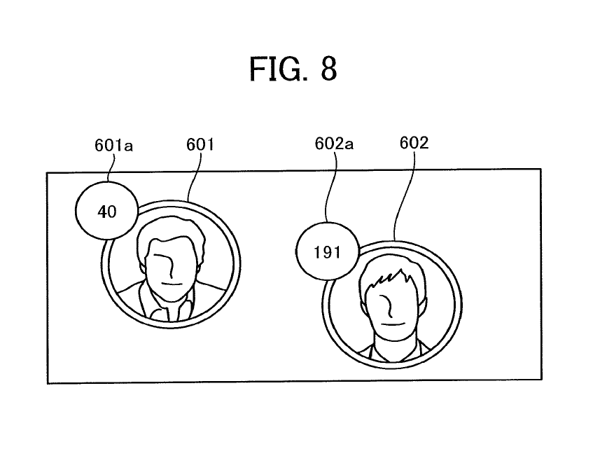

In the above description, when the information presentation unit 104 receives the search result, the icon corresponding to the search result is displayed on the touch panel display 504 (the display unit 112). However, the present disclosure is not limited thereto. For example, when the search condition for the keyword is designated beforehand and the number of the search conditions is fixed, the information presentation unit 104 may cause the touch panel display 504 to display the icons corresponding to the search condition in discriminable form. In this case, when receiving the search result for the search condition, the information presentation unit 104 may change the icon being displayed to indicate that the search result has been received, for example, by a display of a search result score as illustrated in FIG. 8.

In addition, as illustrated in FIG. 5, it is desirable that the icons corresponding to the respective search results are displayed in the corner of the touch panel display 504 so that the function of information presentation device 10 as the electronic whiteboard is not obstructed. For example, as illustrated in FIG. 5, conceivably, the icons corresponding to each search result can be displayed in a display area other than the display area in which the contents under discussion are written.

FIG. 6 is a diagram illustrating examples of the icons respectively corresponding to the plurality of search conditions. For example, at the beginning of the meeting, the icons briefly representing search conditions as illustrated in FIG. 6, like the icon displaying at least a part of the search condition (in the example of FIG. 6, the information source to be searched (web, minutes, document management system 40, etc.)), may be displayed on the touch panel display 504, since the icon including only the person's face as illustrated in FIG. 5 may be difficult to recall the search condition. Displaying the icon representing search condition causes the meeting participants to feel as if the person indicated by the icon is participating in the meeting and to grasp what kind of search condition the search result was obtained. For example, in FIG. 6, the icons of “web search” and “web search 2” indicate search conditions for performing keyword search on the web, and it is assumed that search methods (for example, using different search engines) are different. In addition, the icon of “search from document management system” indicates searching for the keyword in the in-house document management system 40 instead of the web.

Information Presentation Processing by the Information Presentation System

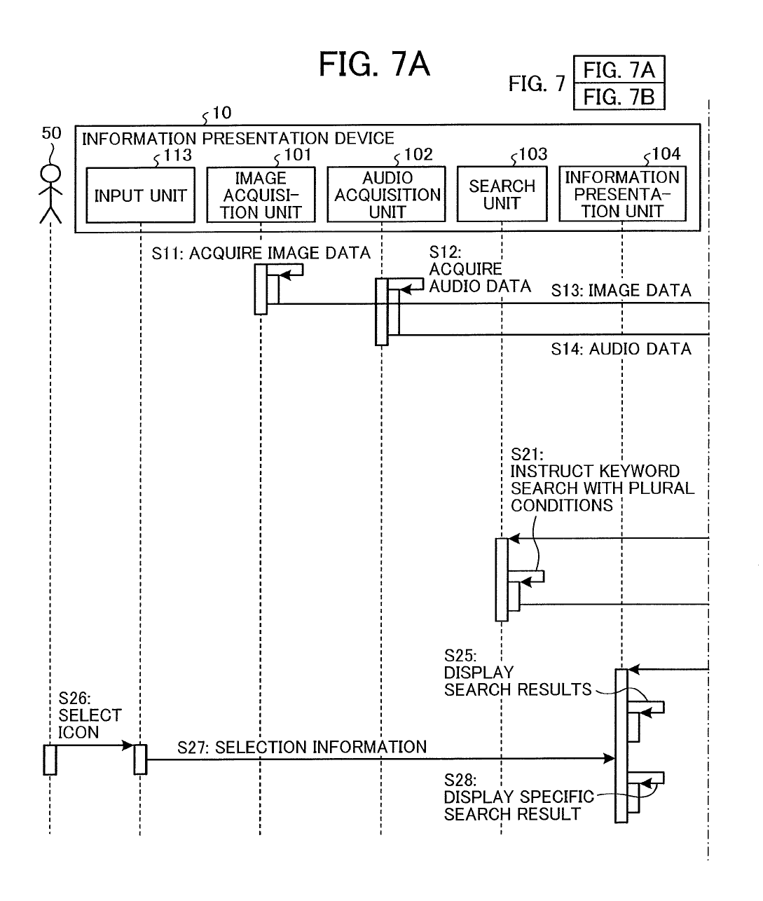

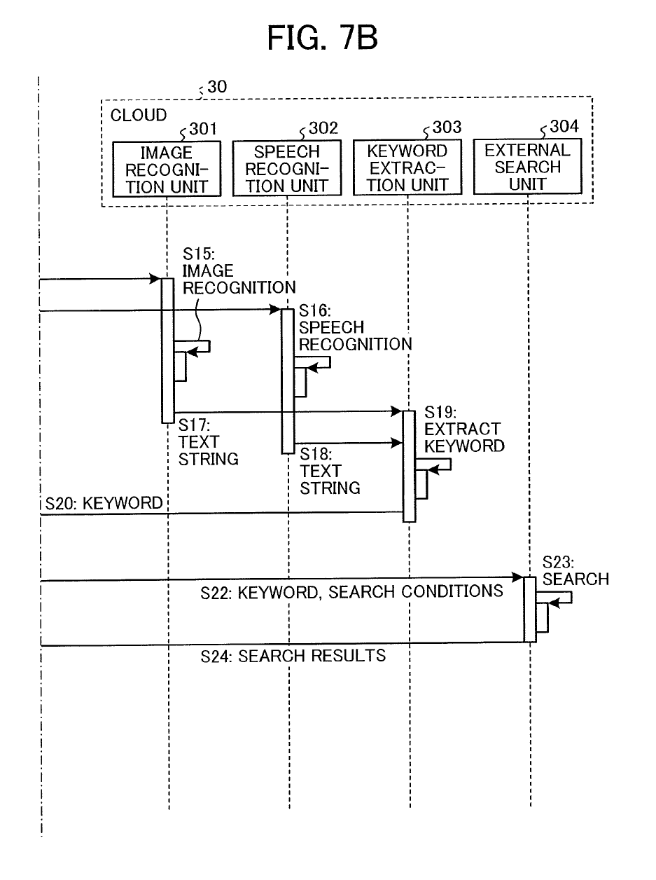

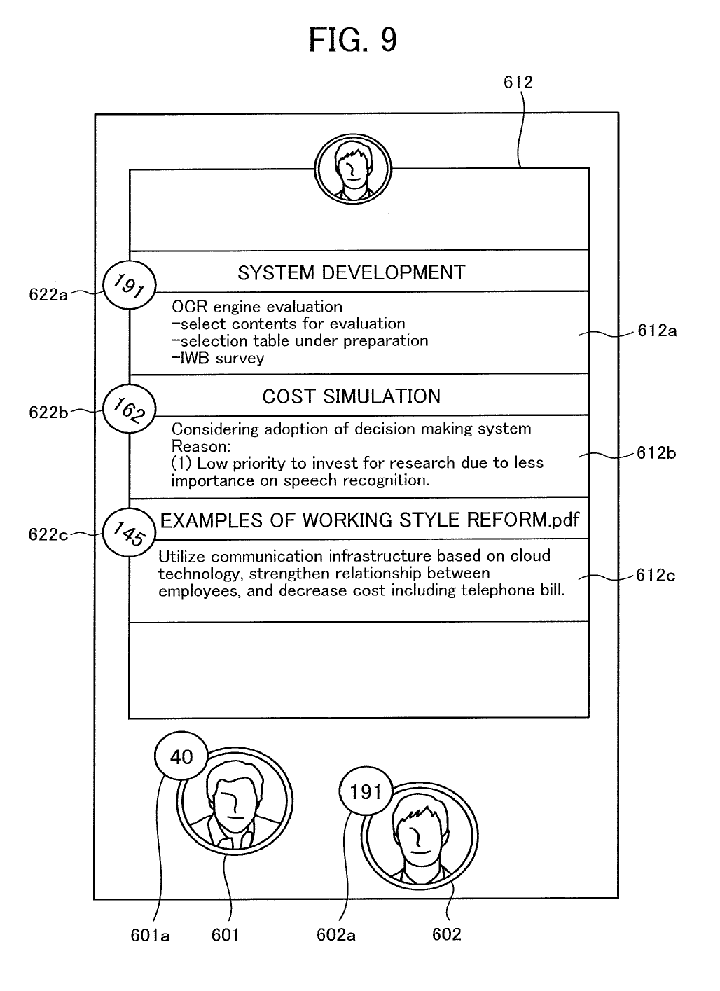

FIG. 7A and FIG. 7B are sequence diagrams illustrating information presentation processing of the information presentation system 1 according to the present embodiment. FIG. 8 is a diagram illustrating an example of displaying the scores of respective search result on the icon corresponding to each search condition in the information presentation device 10 according to the present embodiment. FIG. 9 is a diagram illustrating the search result displayed when any one of the icons corresponding to the search conditions is selected in the information presentation device 10 according to the present embodiment. A description is given below of the information presentation processing of the information presentation system 1 according to the present embodiment with reference to FIG. 7A through FIG. 9.

In step S11, the image acquisition unit 101 of the information presentation device 10 acquires the image data of the image projected by the projector 25 captured by the camera 511, the image data displayed by the display unit 112 (touch panel display 504), the image data stored in the PC 20, or the like. The image acquisition unit 101 may acquire the image data at regular intervals or only intermittently.

In step S12, the audio acquisition unit 102 of the information presentation device 10 acquires the audio data of the participant's voice signal collected (input) by the microphone 505. For example, the audio acquisition unit 102 may acquire the audio data at regular intervals, intermittently, or during a period in which the voice signal is detected.

The image acquisition unit 101 transmits the acquired image data to the cloud 30 via the network communication unit 106 and the network 2 to recognize text string using image recognition.

The audio acquisition unit 102 transmits the acquired audio data to the cloud 30 via the network communication unit 106 and the network 2 to recognize text string using speech recognition.

In step S15, the image recognition unit 301 of the cloud 30 performs the image recognition on the image data received from the information presentation device 10 via the network 2 and recognizes the text string included in the image data.

In step S16, the speech recognition unit 302 of the cloud 30 performs the speech recognition on the audio data received from the information presentation device 10 via the network 2 and recognizes the text string from the audio data.

In step S17, the image recognition unit 301 transmits the text string recognized by the image recognition to the keyword extraction unit 303. When the image recognition unit 301 and the keyword extraction unit 303 are implemented by different computer resources or another cloud service, the image recognition unit 301 temporarily transmits the recognized text string to the information presentation device 10, and the information presentation device 10 may transmit the received text string to the keyword extraction unit 303 implemented by another computer resource or another cloud service.

In step S18, the speech recognition unit 302 transmits the text string recognized by the speech recognition to the keyword extraction unit 303. When the speech recognition unit 302 and the keyword extraction unit 303 are implemented by different computer resources or another cloud service, the speech recognition unit 302 temporarily transmits the recognized text string to the information presentation device 10, and the information presentation device 10 may transmit the received text string to the keyword extraction unit 303 implemented by another computer resource or another cloud service.

In step S19, the keyword extraction unit 303 of the cloud 30 extracts the keyword from the text string recognized by the image recognition unit 301 and the speech recognition unit 302. The method of extracting keyword from the text string is as described above.

In step S20, the keyword extraction unit 303 transmits the extracted keyword to the information presentation device 10 via the network 2.

In step S21, in response to receiving the keyword via the network communication unit 106, the search unit 103 of the information presentation device 10 instructs the keyword search of the keyword based on the plurality of search conditions.

The search unit 103 transmits an instruction for the keyword search along with the keyword and the search conditions to the cloud 30 or the document management system 40 and the like. In the example of FIG. 7A and FIG. 7B, the search unit 103 transmits the keyword search instruction based on the search conditions to the external search unit 304 of the cloud 30, with the keyword and the search conditions, via the network communication unit 106 and the network 2.

In step S23, in response to receiving the search instruction, the keyword, and the search conditions via the network 2, the external search unit 304 of the cloud 30 searches for the keyword based on each of the plurality of search conditions.

In step S24, the external search unit 304 transmits each search result of the keyword search based on the plurality of search conditions to the information presentation device 10 via the network 2. The search result by the external search unit 304 includes not only information related to the searched keyword but also the score indicating the number of searched information items, the degree of relevance between the keyword and the searched information items, and the like.

In step S25, in response to receiving the search results via the network communication unit 106, the information presentation unit 104 of the information presentation device 10 displays the search results on the display unit 112.

Specifically, for example, the information presentation unit 104 causes the display unit 112 to display the icon corresponding to each search result based on each search condition. In the example illustrated in FIG. 8, the information presentation unit 104 displays the icons 601 and 602 on the display unit 112, each icon corresponding to each search result (each search condition). Further, the information presentation unit 104 displays the scores 601a and 602a included in the search results close to the icons 601 and 602 respectively. By displaying the scores indicating the importance or the relevance of the search results, it is possible to compare the importance and the relevance of the search results based on each search condition.

In step S26, the user 50 (one of the meeting participants or the like) can select any one of the icons indicating the search results displayed on the display unit 112 via the input unit 113 (the touch panel display 504).

For example, when the user 50 feels the information from the in-house document management system 40 is needed, the user 50 may select the icon indicating the search result from the document management system 40. Further, even if the user 50 feels that the information in the in-house document management system 40 is more appropriate than the information on the web, if the score of the icon corresponding to the document management system 40 is low, the user 50 may select the icon corresponding to the search result from the web and see the specific search result.

In step S27, the input unit 113 sends selection information of the user 50 to the information presentation unit 104.

In step S28, the information presentation unit 104 displays the specific search result related to the icon indicated by the received selection information, among the icons indicating each search result.

As illustrated in FIG. 9, when the user 50 selects the icon 602, the information presentation unit 104 displays the search result 612 including specific information related to the search result corresponding to the icon 602. In the example illustrated in FIG. 9, three pieces of information (search result display sections 612a to 612c) are displayed as specific information included in the search result corresponding to the icon 602, and corresponding scores (scores 622a to 622c) are displayed close to the respective information. The score 602a displayed close to the icon 602 illustrated in FIG. 8 matches with the score 622a which is the maximum score among the scores for the search result display sections 612a to 612c illustrated in FIG. 9.

Steps S11 through S28 described above are an example of the information presentation processing of the information presentation system 1 of the present disclosure.

As described above, in the information presentation system 1 according to the present embodiment, the keyword is extracted from the image on the electronic whiteboard or the participant's utterance in the meeting, and the keyword search is performed based on the preset search conditions. Each search result based on the plurality of search conditions is presented in discriminable form such as display of an icon corresponding to each search result. As described above, since the keywords related to the meeting are searched by each of the plurality of search conditions, the possibility of obtaining an expected search result is increased.

In addition, each search result presented in the discriminable form is selectable, and detailed information is displayed on the selected search result. With this, it is possible to confirm the content of the optimum or suitable search result according to the situation of the meeting, and the progress of the meeting can be improved.

Also, information indicating the degree of importance or the degree of relevance of the search results accompanying each search result presented in a discriminable form is displayed. With this, it is possible to compare the importance and the relevance of the search results based on each search condition.

The image acquisition unit 101 and the audio acquisition unit 102 acquire the image data and the audio data at regular intervals or only intermittently and extract the keyword. Thus, optimum or suitable related information can be obtained during the meeting.

Also, each search result is displayed on the display unit 112 in a display area other than the display area in which contents related to discussion in the meeting are written. Thereby, it is possible to prevent the information presentation device 10 from obstructing the display of the contents of the meeting.

Further, when displaying each search result on the display unit 112 in a discriminable form, at least a part of the search condition corresponding to the search result is displayed together. With this, it is possible to grasp what kind of search condition the search result was obtained.

In the above-described embodiment, when at least one of the functional units of the information presentation device 10 is implemented by executing a program, the program is provided by being incorporated in advance in the ROM or the like. Alternatively, the program executed in the information presentation device 10 according to the embodiment described above may be stored in a computer readable recording medium, such as a compact disc read only memory (CD-ROM), a flexible disk (FD), a compact disc recordable (CD-R), and a digital versatile disk (DVD), in a file format installable or executable. Further, the program executed by the information presentation device 10 according to the embodiment described above may be stored on a computer connected to a network such as the internet and downloaded via the network. Alternatively, the program executed in the information presentation device 10 according to the embodiment described above may be provided or distributed via a network such as the internet. In addition, the program executed by the information presentation device 10 of the above embodiment has a module configuration including at least one of the above-described functional units, and as the actual hardware, the CPU is connected to the storage device (for example, the storage device 503), and by executing the program, the respective functional units described above are loaded on the main storage device (for example, the memory 502) and are configured.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information presentation device comprising:
circuitry configured to;
instruct searching based on a plurality of search conditions for a keyword extracted from an utterance or an image displayed on a display; and
display search results corresponding to each search condition in a discriminable form.

2. The information presentation device of claim 1, wherein the circuitry is further configured to;
acquire image data of the image displayed on the display at regular intervals or intermittently;
acquire audio data of a voice signal collected by a microphone at regular intervals or intermittently; and
instruct keyword searching based on the plurality of search conditions for the keyword extracted from the image data acquired from the image displayed on the display and the audio data acquired from the voice signal.

3. The information presentation device of claim 1 wherein;
each of the search results displayed on the display can be selected by a selection operation; and
specific information on the selected search result among the search results is displayed on the display.

4. The information presentation device of claim 1, wherein each of the search results is displayed on the display together with information indicating importance or relevance to the keyword of each search result.

5. The information presentation device of claim 1, wherein each of the search results is displayed on the display together with at least a part of the search conditions for each search result.

6. The information presentation device of claim 1, wherein the search results are displayed separately from displaying content.

7. An information presentation system, comprising:
the information presentation device of claim 1;
a recognition unit to recognize a text string from an utterance or an image displayed on a display; and
an extraction unit to extract a keyword from the text string recognized by the recognition unit.

8. The information presentation system of claim 7, further comprising an external search unit to search information sources indicated in a plurality of search conditions for a keyword.

9. An information presentation method, comprising:
searching information sources indicated in a plurality of search conditions for a keyword extracted from an utterance or an image displayed on a display; and
presenting search results corresponding to each of the search conditions on the display in a discriminable form.

10. The information presentation method of claim 9, further comprising:
acquiring image data of the image displayed on the display at regular intervals or only intermittently;
acquiring audio data of the voice signal of utterance at regular intervals or only intermittently; and
instructing keyword search based on the plurality of search conditions for the keyword extracted from the image data acquired from the image displayed on the display unit and the audio data acquired from the voice signal.

11. The information presentation method of claim 9, further comprising selecting any of the search results displayed on the display and displaying specific information on the selected search result among the search results.

12. The information presentation method of claim 9, further comprising displaying the information indicating importance or relevance to the keyword together with each of the search results.

13. The information presentation method of claim 9, further comprising displaying at least a part of the search conditions for each search result together with each of the search results displayed on the display.

14. The information presentation method of claim 9, further comprising displaying the search results separately from displaying content.
